(19) United States
(12) Patent Application Publication
(10) Pub. No.: US 2003/0068975 A1
(43) Pub. Date: Apr. 10, 2003

(54) Integrated cellular and ad hoc relaying system

(75) Inventors: Chunming Qiao, East Amherst, NY (US); Hongyi Wu, Lafayette, LA (US); Ozan Tonguz, Pittsburgh, PA (US)

Correspondence Address: SIMPSON & SIMPSON, PLLC, 5555 MAIN STREET, WILLIAMSVILLE, NY, 14221-5406, US

(73) Assignee: The Research Foundation of SUNY, Amherst, NY

(21) Appl. No.: 10/213,058

(22) Filed: Aug. 6, 2002

Related U.S. Application Data
(60) Provisional application No. 60/310,394, filed on Aug. 6, 2001.

(51) Int. Cl. H04Q 7/20

(52) U.S. Cl. 455/11.1; 455/422; 455/561

(57) ABSTRACT

A method and apparatus for dynamically balancing the load among different cells in a cellular phone system in a cost-effective way is disclosed. The method for establishing a connection between a first mobile host and a second mobile host comprises: identifying a first relaying station in communication range of the first mobile host, identifying a communication path between the first relaying station and the second mobile host, establishing a connection between the first mobile host and the first relaying station, and establishing a connection between the first relaying station and the second mobile host. The present invention also comprises a method for establishing a connection between a first mobile host and a second mobile host within a system having a limited number of primary frequencies, and an apparatus for performing the above-identified methods.

### RELATED APPLICATION

This patent application under 35 U.S.C. §119 which claims the benefit of U.S. Provisional Application Serial No. 60/310,394, filed Aug. 6, 2001, incorporated by reference herein.

### FIELD OF THE INVENTION The invention relates generally to cellular systems, and, more particularly, to an integrated cellular and ad hoc relaying system (ARS).

### BACKGROUND OF THE INVENTION

With the unprecedented increase in demand for personal mobility and dependence on personal communications, the wireless carriers and infrastructure providers now face a major challenge in meeting the increased bandwidth demand of exploding mobile Internet traffic. The cellular concept was introduced for wireless communication to address the problem of having scarce frequency resource. It is based on the sub-division of geographical area to be covered by the network into a number of smaller areas called cells. Frequency reuse in the cells far away from each other increases system's capacity. But at the same time, the cell boundaries prevent the channel resource of a system to be fully available for users. No access to data channels (DCH's) in another cell by the mobile host (MH) limits the channel efficiency and consequently the system capacity. More specifically, when a call request arrives in a cell that has no free DCH's, this call will be blocked or dropped although there are free DCH's in other cells in the system. Moreover, the presence of unbalanced and bursty traffic (e.g., wireless data traffic) will exacerbate the problem of having limited capacity and no access to channels in other cells in existing cellular systems. As a significant number of calls may be blocked and dropped due to localized congestion even though the traffic load does not reach the maximum capacity of the entire system, and the locations of congested cells (called hot spots) vary from time to time (e.g., downtown areas on Monday morning, or amusement parks on Sunday afternoon), it is difficult, if not impossible, to provide the guarantee of sufficient resource in each cell in a cost-effective way. In fact, increasing bandwidth of a cellular system (e.g., the number of DCH's in each cell) can increase the system capacity but not the efficiency to deal with the time-varying unbalanced traffic.

Prior Art Attempted Solutions

a. Cell splitting is a strategy used to deal with an increased number of uses in a given coverage area. This is done by further dividing a cell to yield more (smaller) cells. It offers the advantage that a communication channel, or a band of frequencies, can be used simultaneously by many callers if these callers are spaced physically far enough apart that their calls do not interfere with one another. The splitting of cell areas by adding new base transceiver stations (BTS's) provides for an increasing amount of channel reuse and, hence, increasing subscriber serving capacity (Harri Holma and Antti Toskala, WCDMA For UMTS, page 44. John Wiley & Sons, 2000).

b. Cell sectorization is another way to deal with an increased number of users in the coverage area. It uses a directional antenna to reduce the co-channel interference. In this scheme, each cell is divided into three or six sectors and uses three or six directional antennas at the BTS. Each sector is assigned a set of channels (frequencies). This increases the channel reuse rate, and consequently the system capacity (V. K. Garg and J. E. Wilkes, Wireless and Personal Communications Systems, pages 88-90. Prentice Hall, 1996).

c. Another proposed improvement is dynamic channel borrowing (or assignment) or DCB/DCA for short. In traditional cellular system designs, the allocation of frequency channels to cells is fixed, i.e., once a frequency channel has been allocated to a cell, it cannot be used by other cells that may interfere with the use of the channel in the cell that the particular channel has been assigned to. Realizing that most of the time, all channels will not be in use in all cells, the channels may be “borrowed” from other cells, given that the borrowing of the channel will not cause interference in other cells (Satinder Singh and Dimitri Bertsekas, Reinforcement learning for dynamic channel allocation in cellular telephone systems. In Michael C. Mozer, Michael I. Jordan, and Thomas Petsche, editors, Advances in neural information processing Systems, volume 9, page 974. The MIT Press, 1997).

d. Cell breathing is a phenomenon where the site's coverage area shrinks as it struggles to accommodate more users. As more handsets enter a cell, ambient RF noise and link loss increase, which causes the signal to degrade, and the cell size has to be reduced to decrease the active users and interference. Although this allows the system to dynamically adjust the cell coverage, it cannot increase the system capacity. Moreover, an unhappy result is that a user near the cell fringe might not be able to make or maintain a call (http://wireless.iop.org/article/feature/2/3/4).

e. ODMA (Opportunity Driven Multiple Access) is an optional extension of the third generation mobile communication standard called UMTS (Universal Mobile Telecommunication System). It defines a special ad-hoc network, where each mobile node may connect to the BTS through a relaying path with the assistance of the forthcoming mobile nodes. Using ODMA technology the mobile stations beyond the border of the coverage area associated with the base stations are still able to get service. Thus the coverage of the system raises, on the other hand the base stations can work in a spectrally efficient manner over a short range (V. K. Garg and J. E. Wilkes. Wireless and Personal Communications Systems, page 97. Prentice Hall, 1996).

f. In the paper, “MACA-An Efficient Channel Allocation Scheme in Cellular Networks,” in IEEE Global Telecommunications Conference, December 2000, the authors proposed a channel allocation scheme, i.e., mobile-assisted connection-admission (MACA) algorithm, to achieve load balancing in a cellular network. In MACA, an ad hoc overlay network is added on the fixed-infrastructure cellular network. Channels assigned to this ad hoc network can be used to help the fixed-infrastructure to achieve load balancing. Specifically, a user in a congested cell may set up a multi-hop relaying route through other users, using the ad hoc channels, to nearby non-congested cell. Thus, the call blocking/dropping probability may be reduced (X. -X. Wu, B. Mukerjee, and S. -H. Gary Chan. Maca—an efficient channel allocation scheme in cellular networks. In IEEE Global Telecommunications Conference (Globecom '00), volume 3, pages 1385-1389, 2000).

g. In the paper, “Multihop Cellular: A New Architecture for Wireless Communications”, in INFOCOM 2000, the authors proposed a new architecture, called Multihop Cellular Network (MCN), as a viable alternate to the conventional single hop cellular networks. More specifically, a MH in MCN can reach the BTS in the same cell via a multihop route involving other MH's. Thus, either the number or the transmission range of BTS's can be reduced (Y. D. Lin and Y. C. Hsu. Multihop cellular: A new architecture for wireless communication. In IEEE INFOCOM '2000, pages 1273-1282, 2000).

h. In the paper, “A new hierarchical routing protocol for dynamic multihop wireless networks” in INFOCOM'97, the authors presented a hierarchical structure for wireless mobile systems with a fixed backbone. In order to access the backbone, all MH's have to go through a Mobile Base Station (which can be thought of as a cluster head). The major contribution of this work is the routing algorithm that balances the cost of location-update and path-finding operations by partitioning the terminals and mobile base stations to produce a virtual topology. Based on the virtual topology, each network entity stores a fraction of the network topology information and maintains the routing efficiency (I. F. Akyildiz, Wei Yen, and Bulent Yener. A new hierarchical routing protocol for dynamic multihop wireless networks. In IEEE INFOCOM'97, pages 1422-1429, 1997).

### DISADVANTAGES OF THE PRIOR WORK

Prior solutions a, b and c, namely cell splitting, cell sectorization and dynamic channel borrowing can increase the system capacity, but they all require modifications in existing frequency reuse planning and BTS. More specifically, the frequency used in one cell or sector cannot be used in another cell or sector nearby because of the co-channel interference. So whenever these strategies are applied to existing cellular systems, the frequency reuse pattern has to be rearranged to guarantee the required signal-to-noise ratio. This is also one reason that the first two strategies cannot be applied to dealing with bursty traffic that causes temporal congestion (or the hot-spot problem) by using dynamic load balancing.

In addition, it may be very costly to install new BTS's in each of those smaller cells when a cell is split, especially in very crowded downtown areas of big cities like New York or Los Angeles (in such geographical areas, the cost of the so called “right-of-way” might be more expensive than the hardware cost of the BTS's. In particular, prior solution c requires a central controller for the entire cellular system, and thus is not scalable.

Prior solution d, cell breathing, is specific to CDMA technology. It can dynamically increase or decrease the cell coverage, but the capacity may not be increased. Moreover, it may result in call blocking/dropping to the users near the cell fringe.

Prior solutions e, f and g rely on the MH's to be the intermediate nodes and set up the relaying routes, and thus share many disadvantages in terms of security (authentication, privacy), billing, routing, reliability, mobility management (of the MH's), and so on with mobile ad-hoc networks. Moreover, the main goals of ODMA and the multihop cellular systems are not to increase system capacity. ODMA is used to increase the cell coverage. The multihop cellular systems may be used to reduce either the number of BTS's or the transmission power of each BTS, but it can no longer guarantee a full coverage of the area. In fact, even in the ideal case where every MH in an area uncovered by any BTS can find a relaying route (through other MH's), the multihop approach will neither increase the system capacity nor decrease the call blocking/dropping probability, unless a large percentage of the calls are intra-cell calls (i.e., calls whose source and destination are in the same cell), which usually is not the case in practice.

In particular, MACA did not mention the use of any novel, network managed devices and associated methods for relaying purposes.

The prior solution h includes a fixed cellular infrastructure, and the ARS's can be mobile and used to relay between MH's and the fixed BTS's. However, in the present invention, the MH's have two air (or radio) interfaces so that they may communicate with BTS's directly without going through ARS's. In addition, most, but not all ARS's are under the control of a MSC, and thus may have limited mobility. Such a feature is important to ensure that a relaying route can be set up fast and maintained with a high degree of stability.

### SUMMARY OF THE INVENTION

The present invention broadly comprises a method and apparatus for dynamically balancing the load among different cells in a cellular phone system in a cost-effective way. The method for establishing a connection between a first mobile host and a second mobile host comprises: identifying a first relaying station in communication range of the first mobile host, identifying a communication path between the first relaying station and the second mobile host, establishing a connection between the first mobile host and the first relaying station, and establishing a connection between the first relaying station and the second mobile host.

The present invention also comprises a method for establishing a connection between a first mobile host and a second mobile host within a system having a limited number of primary frequencies comprising: identifying a first relaying station in communication range of a third mobile host currently using one of the primary frequencies, replacing the connection of the third mobile host on one of the primary frequencies with a connection between the first relaying station and the third mobile host on a relaying frequency, and establishing a connection between the first and second mobile hosts on the primary frequency made available by the connection between the first relaying station and the third mobile host on a relaying frequency.

The above method can be used multiple times for establishing a single call in a “cascade” fashion. The “cascade” method comprises: identifying a third mobile host currently using a first primary frequency, identifying a first relaying station in communication range of a fourth mobile host currently using a second primary frequency, replacing the connection of the fourth mobile host on the second primary frequency with a connection between the second relaying station and the fourth mobile host on a relaying frequency, replacing the connection of the third mobile host on the first primary frequency with a connection on the second primary frequency, and establishing a connection between the first and second mobile hosts on the first primary frequency.

The present invention also comprises an apparatus for relaying communications between mobile hosts comprising: wireless communication means for communication with a mobile switching center, means to receive communication signals on a relaying frequency, and means to send communication signals on a relaying frequency.

The present invention further comprises an apparatus for relaying communications between mobile hosts comprising: wireless communication means for communication with a mobile switching center, means to receive communication signals on a primary frequency, and means to send communication signals on a primary frequency.

### BRIEF DESCRIPTION OF THE DRAWINGS

The nature and mode of operation of the present invention will now be more fully described in the following detailed description of the invention taken with the accompanying drawing figures, in which:

FIG. 1 is a relaying example where MH X communicates with BTS A through two Ad-hoc Relaying Stations (ARS's) (It may also communicate with MH X′ through ARS 1).

FIG. 2 is a secondary relaying to free up a channel for MH X. (a) MH Y to BTS A, (b) MH Y to MH Y′, or (c) cascaded secondary relaying (i.e. MH Y to BTS C and MH Z to either MH Z′ or BTS D).

FIG. 3 is a non-congestion-inducted (NCI) relaying to overcome shadows.

FIG. 4 is a possible air interface design for an ARS.

FIG. 5 is a seed growing approach.

FIG. 6 is an example of clusters, and group leaders under hierarchical management.

### DETAILED DESCRIPTION OF THE PREFERRED EMBODIMENT

An overview of Integrated Cellular and Ad Hoc Relaying System (iCAR)

The basic idea of the iCAR system of the present invention is to place a number of so-called Ad hoc Relaying Stations or ARS's, sometimes also called Mobile (Ad-hoc) Relaying Stations or ARS due to their managed mobility, at strategic locations, which can be used to relay signals between MH's and base stations. By using ARS's, it is possible to divert traffic from one (possibly congested) cell to another (non-congested) cell. This helps to circumvent congestion, and makes it possible to maintain (or hand-off) calls involving MH's that are moving into a congested cell, or to accept new call requests involving MH's that are in a congested cell.

To simplify the description, we focus on cellular systems where each BTS is controlled by an MSC, although the concept is applicable to the third generation (3G) systems and beyond where Radio Node Controllers (RNCs) are used.

Major differences between BTS's and the present invention ARS's are as follows. Once a BTS is installed, its location is fixed since it often has a wired (or microwave) interface to a mobile switching center (MSC) (and a backbone network). An ARS, on the other hand, is a wireless communication device deployed by a network operator. It has much lower complexity and fewer functionalities than that needed for a BTS. In addition, it may, under the control of an MSC, have limited mobility, and thus can communicate directly with an MH, a BTS, or another ARS. Each ARS has two air interfaces, the C (for cellular) interface for communications with a BTS and the R (for relaying) interface for communicating with an MH or another ARS. Also, MH's have two air interfaces; the C interface for communicating with a BTS, and the R interface for communicating with an ARS.

Basic Operation

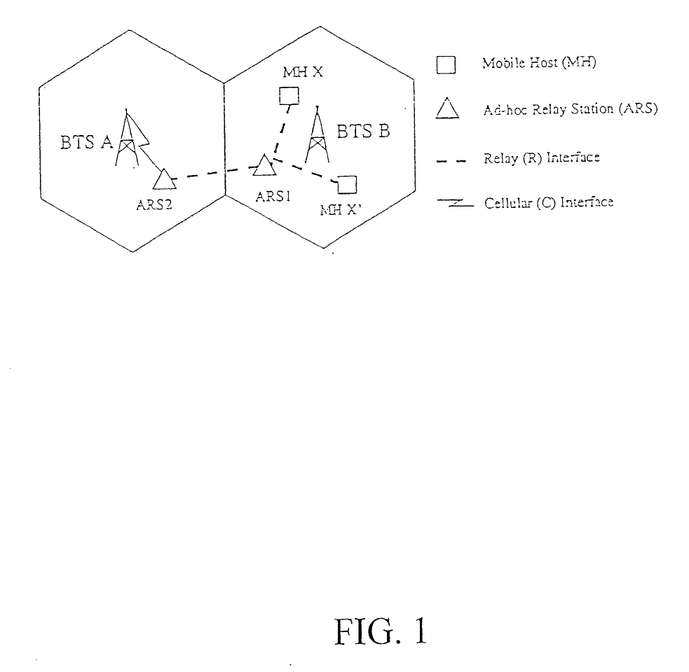

An example of relaying is illustrated in FIG. 1 where MH X in cell B (congested) communicates with the BTS in cell A (or BTS A, which is non-congested) through two ARS's (there are at least one ARS along what we call a relaying route).

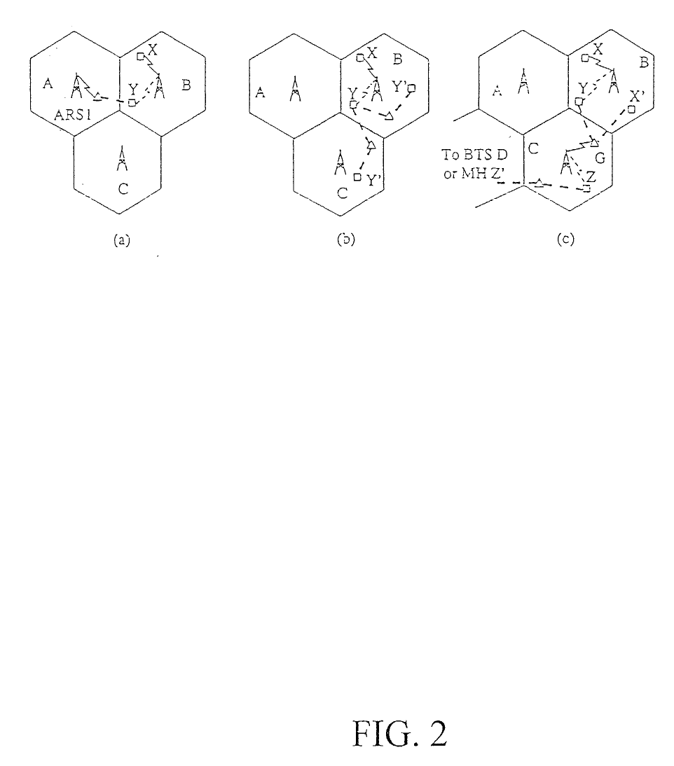

Among the ARS's involved in relaying, we may call an ARS which directly communicates with an MH (e.g., ARS 1 in Figure) a proxy, and an ARS which directly communicates with a BTS (e.g., ARS 2 in FIG. 1) a gateway (an ARS can serve as both a proxy and a gateway at the same time as illustrated in FIG. 2(a)). Other ARS's along a relaying route use the R interface only. The gateway ARS always uses a DCH allocated to it by a MSC to communicate directly with a BTS.

In the present application, “direct communication” between a first and a second unit is intended to mean that each of the first and second units receive the original signals sent from the other unit. If a connection does not involve “direct communication,” then at least one additional unit is receiving the original signals and rebroadcasting them to the other unit. Multiple units can receive and rebroadcast the signals to increase the distance that the first and second unit can be from each other and still have a communication connection.

Congestion-Induced (CI) Relaying

A principle benefit of the integration of the cellular and Ad-hoc relaying technologies is that both the blocking probability of new calls to/from a congested cell, and the call dropping probability during hand-offs to a congested cell, can be drastically reduced via what we call congestion-induced (or CI) relaying. This is illustrated below.

New Call

In an existing cellular system, if MH X is involved in a new call (as a caller or callee) but it is in a congested cell B, the new call will be blocked. In the next generation wireless system of the present invention, with integrated cellular and relaying technologies, the call does not have to be blocked. More specifically, MH X which is in the congested cell B, can switch over to the R interface to communicate with an ARS in cell A, possibly through other ARS's in cell B (see FIG. 1 for an example). We call this strategy that establishes a relaying route between MH X (in a congested cell) and a BTS in a nearby non-congested cell “primary relaying.”

With primary relaying, MH X can communicate with BTS A, albeit indirectly (i.e., through relaying). Hereafter, we will refer to the process of changing from the C interface to the R interface (or vice versa) as switching-over, which is similar to (but different from) frequency-hopping. Of course, MH X may also be relayed to another nearby non-congested cell other than cell A. Finally, a relaying route between MH X and its corresponding (i.e., caller or callee) MH X′ may also be established, (in which case, both MH's need to switch over from their C interfaces to their R interfaces), even though the probability that this happens could be very low.

If primary relaying is not possible because, for example in FIG. 1, ARS 1 is not close enough to MH X to be a proxy (and there are no other nearby ARS's), one may resort to secondary relaying so as to free up a DCH from BTS B for use by MH X. Two basic cases are illustrated in FIGS. 2(a) and (b), respectively, where MH Y denotes any MH in cell B that is currently involved in a call. More specifically, as shown in FIG. 2(a), one may establish a relaying route between MH Y and BTS A (or any other cell). In this way, after MH Y switches over, the DCH used by MH Y can now be used by MH X. Similarly, as shown in FIG. 2 (b), one may establish a relaying route between MH Y and its corresponding MH Y′ in cell B or in cell C, depending on whether MH Y is involved in an intra-cell call or an inter-cell call. Note that, given that cell B is congested which means that there are a lot of on-going calls (or candidates for MH Y), the chance that case (b) in FIG. 2 could occur should be better than that a relaying route between MH X and MH X′ can be established using primary relaying (as in FIG. 1). In addition, although the concept of having such an MH-to-MH call via ARS's only (i.e., no BTS's are involved) is similar to that in Ad-hoc networking, a distinct feature (and advantage) of the proposed integrated system is that an MSC can perform (or at least assist in performing) critical call management functions such as authentication, billing, locating the two MH's and finding and/or establishing a relaying route between them, as mentioned earlier. Such a feature is also important to ensure that switching-over of the two MH's (this concept is not applicable to Ad-hoc networks) is completed fast enough so as not to disconnect the on-going call involving the two MH's or not to cause severe quality of service (QoS) degradation (though the two MH's may experience a “glitch” or jitter).

If neither primary relaying, nor basic secondary relaying as shown in FIG. 2(a) and (b) works, the new call may still be supported. More specifically, assume that there is a relaying route, which can be either primary or secondary relayed, between MH X and ARS, say G (for gateway), in a nearby cell C that unfortunately is congested. As shown in FIG. 2(c), one may apply any of the two basic secondary relaying strategies described above in the congested cell C (i.e., in a cascaded fashion) as if ARS G is being “handed-over” (see discussion below). Hence, if a relaying route between an MH (say MH Z) in cell C and either another BTS in a non-congested cell or MH Z′ can be established, ARS G can be allocated the DCH previously used by MH Z in cell C, and in turn MH X can be allocated the DCH previously used by MH Y in cell B if the route between MH Y and ARS G is set up by secondary relay.

Hand-Off

In an existing cellular system, if an MH X involved in a call moves from cell A to cell B, a request for hand-off will be sent as soon as the power level from BTS A received by MH X goes below a certain threshold (and that from BTS B is becoming higher). A successful hand-off will take place, usually within a few hundred milliseconds (depending on the moving speed of the MH) before the received power from BTS A reaches an unacceptable level.

If cell B is congested, the hand-off request may be queued for a short period of time, e.g., up to a few tens of milliseconds as long as the received power is still above the unacceptable level. If the congestion in cell B persists, that is, there is still no DCHs available in cell B after this short period of blocking time, the call will be dropped.

In the proposed integrated system, MSC may apply the primary relaying strategy to establish a relaying route between MH X to a BTS in a nearby non-congested cell (similar to FIG. 1) or the secondary relaying strategies and cascaded relay to free up DCH's in cell B for use by MH X (similar to FIG. 2). In this way, the handoff call can take place successfully.

Note that by applying the relaying strategies (primary and secondary) to establish a relaying route between an MH in a congested cell B and a BTS in another cell (not necessarily an immediate neighbor), new calls involving MH's in cell B and hand-off calls involving MH's moving into cell B can now be supported, it is as if cell B has “borrowed” some DCH's from other cells. In other words, the capacity of cell B has been effectively increased, thus eliminating (or at least alleviating) congestion.

Noncongestion-Induced (NCI) Relaying

Clearly, relaying can also be used to pro-actively balance load among different cells by transferring calls from a heavily-loaded cell to other lightly-loaded, and possibly remote cells (for example, two cells such as B and D in FIG. 2(c), between which there are no relaying routes available). This is one of the main advantages of the proposed approach over channel borrowing whereby a cell can only borrow a pre-determined set of channels from its immediate neighbors.

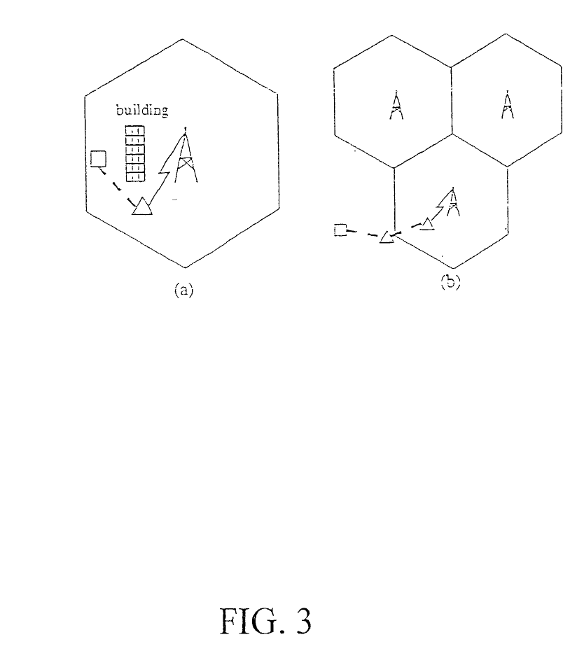

Note that when no cells are currently congested, and relaying is used to, for example, balance load as described above, we might call this type of relaying noncongestion-induced (or NCI). NCI-relaying is also useful to overcome so-called shadows where no coverage by a BTS is available because either there are buildings surrounding an MH, which completely block signals from a nearby BTS to the MH, or no BTS's are close enough to the MH. This is illustrated in FIGS. 3(a) and (b) respectively.

In FIGS. 3(a), an MH behind a building (or buildings) may still receive the signal from a BTS due to multi-path propagation of radio signals, though the signal could be very weak. In such a case, NCI-relaying may improve the signal strength and other QoS performances. As an added benefit of relaying, either NCI or CI, one may reduce the power consumption of an MH since the distance between the MH and the proxy ARS can be much shorter than that between the MH and the BTS.

Air Interface Design

In the following discussion, we assume that the C interface operates at or around 850 MHz, and the R interface (as well as the medium access control (MAC) protocol used) is similar to that used in wireless LANs or Ad-hoc networks and uses an unlicensed band at 2.4 GHz (in the ISM band), even though our concept also applies when different bands are used (for example, 1900 MHz for the C interface and 5 GHz for the R interface).

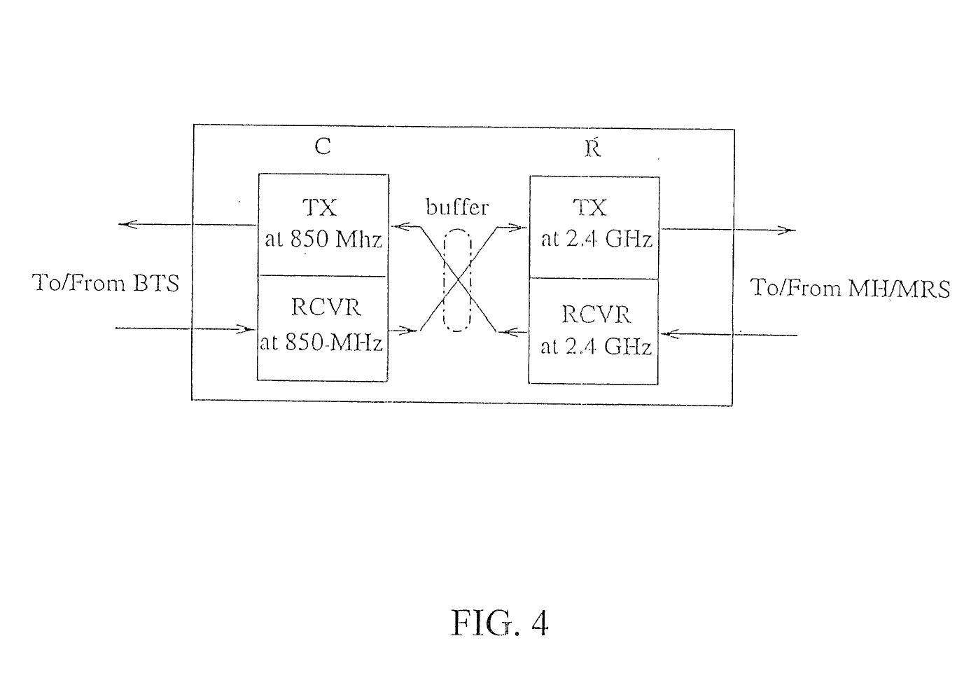

One possible design of the air interface of MH's is thus to have a tunable transceiver (i.e. a tunable transmitter and a tunable receiver) which can operate at 850 MHz and 2.4 GHz alternately. Since an ARS may receive at 2.4 GHz and transmit at 850 MHz (for relaying from an MH to a BTS), and receive at 850 MHz and transmit at 2.4 GHz (for relaying from a BTS to an MH), its air interface is more complex than that of an MH which receives and transmits at a single frequency band, i.e. either 2.4 GHz or 850 MHz. A basic block diagram of a possible air interface design for an ARS is shown in FIG. 4. An alternative is to use just one tunable transceiver for an ARS as well (just as for a MH), but a disadvantage would be that such an ARS cannot perform simultaneous C to R and R to C relaying.

As described earlier, a Proxy ARS directly communicates with (i.e., relay data to and from) a MH using the R-interface, and a gateway ARS directly communicates with a BTS using the C-interface. If a relaying path exists of two or more ARSs, including one proxy and one gateway, ARSs communicate with each other using the R-interface. Otherwise, the only ARS along the relaying path acts both as a proxy and a gateway.

Alternate Design with Minimal Changes to MHs

Note that it is also possible for MH to use the C interface for relaying (i.e., not to have any specialized/dedicated R interface at e.g., 2.4 GHz). The major advantage of this design is that no modifications to MH's are needed. In such a case, the MH will have to switch to one of the Relay-capable DCH's at the C interface for relaying. Also, the ARSs may or may not have the dedicated R-interface (e.g., at 2.4 GHz). If they do, this dedicated R-interface will be used for ARSs to directly communicate with each other only (as a proxy ARS will also use a Relay-capable C interface to directly communicate with a MH). If they don't, all ARSs directly communicate with each other, and with MH's using Relay-capable DCH's. Note that, if no dedicated R interface is used at all, the complexity of the channel assignment and access schemes is likely to be higher, and the systems' performance is likely to suffer.

Assume that a MH operates on a set of DCH's in one single frequency band at the C interface only. In such a case, one may dedicate a subset of channels as Relay-capable DCH's, to be used by any cells. Different cells may also have different subsets of Relay-capable DCH's. The concept can also be applied if a MH operates on more than one set of DCH's, e.g., analog (850 MHz) or digital (1900 MHz). In such a case, when the MH is blocked from using a DCH from one set (850 MHz), it can use a DCH from another set (1900 MHz) as a Relay-capable DCH. Of course, a proxy ARS will have to be able to operate on those Relay-capable DCH's as well. Different ARSs may have different capability, i.e., some can be proxy (only), some can be gateways (only) and some can be both.

Seed Growing Approach for ARS Placement

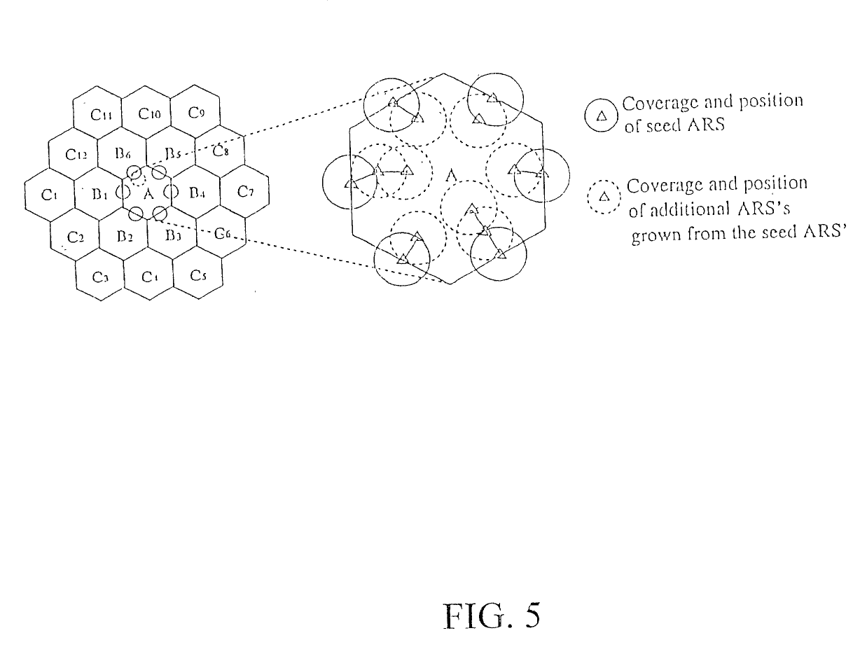

One critical issue in iCAR is ARS placement as iCAR's performance improvement over a conventional cellular system is largely due to its ability to relay traffic from one cell to another. The idea case is that there are enough number of ARS's to cover the entire system and thus ensure that a relaying route can be established between any BTS and an MH located anywhere in any cell. However, when only a limited number of ARS's are deployed in a cell, a natural question is how many ARS's are reasonable and where to place them. We propose a Seed Growing approach whereby one seed ARS is placed on each pair of “shared edges” along the border between two cells. Additional ARS's will grow from the seeds to form a cluster as shown in FIG. 5, where the additional ARS's can communicate with at least one seed via relaying on the R-interface. The seed ARS's can also be placed at the “joint corners” instead.

Number of ARS's and Performance Impact

The increased cost of iCAR over a conventional cellular system is mainly due to the installation of ARS's, which is consequently an important factor for system design. Thus, we have developed methods to determine the required number of ARS's for two situations as follows.

The first situation is the maximum number of ARS's needed in a cell, given the size of a cell and the transmission range of an ARS. Let R and r be the transmission radius of a BTS and an ARS, respectively, and define n=[R²/r²]. In order to provide overlapped coverage of a cell with ARS's so that data can be relayed between any two locations in a cell (without involving a BTS), one needs approximately 2n ARS's, as shown below.

When only a limited number of ARS's are deployed in a cell, we use the Seed Growing approach whereby one seed ARS is placed on each pair of “shared edges” along the border between two cells. Additional ARS's will grow from the seeds as to be discussed later. Since a seed ARS is shared by two cells, and each cell has 6 edges if we model the cells as hexagons, it is obvious that at most 3n seed ARS's are needed in an n-cell system. In fact, the total number of seed ARS's required will be less because it makes no sense to put any ARS's on a “non-shared edge” of a “boundary cell”. Supposing that the radius of each cell is R, then the coverage of all the cells is nπR². If the cells are organized as a near circle whose radius is R′, then πR′²≈nπR², or R′≈R\sqrt{n}. The estimated number of boundary cells is

$$\frac{π {R}^{′2} - {( π ( {R}^{′} - 2 R ) )}^{2}}{π {R}^{2}} = 4 \sqrt{n} - 4.$$

Since each boundary cell has at least two non-shared edges, the number of shared edges is at most E=6n−2└4\sqrt{n}−4−┐. Hence, for a near-circular n-cell system, the maximum number of seed ARS's needed is E/2 or 3 n−└4\sqrt{n}−4┐.

It can be shown that E/2 is the upper bound on the number of ARS's needed for a coverage area of any shape. In a rectangular system of n=nₐ×n_{b} cells, the number of non-shared edges is 4nₐ+4n_{b}−2. Thus, the number of ARS'S needed is S=3nₐn_{b}−2(nₐ+n_{b})+1. Since nₐn_{b}=n, and nₐ+n_{b}≧2\sqrt{n}, we have S≦3 n−└4\sqrt{n}n+1┐. Thus S≦the upper bound found in the previous paragraph, 3n−└4\sqrt{n}−4┐. Therefore, the maximum number of ARS's needed in any shaped system with n cells is 3 n−└4 \sqrt{n}−4┐.

The number of ARS's to achieve a given grade of services. As we mentioned earlier, the performance improvement of an iCAR system in terms of the reduced call blocking probability is due to the relaying ability of a system, which in turn depends on the effective ARS coverage. In order to achieve a given grade of services (QoS), a certain number of ARS's need to be deployed to meet the ARS coverage requirement. We have developed two models to analyze the performance of iCAR for a given ARS coverage. One may make a mapping table including various ARS coverage values and the corresponding QoS, so that system designers can look up the table and find the needed ARS coverage according to the required QoS of the system.

One model is to use the iterative equations, and the blocking probability of primary relaying (Bₐ^{p}) and secondary relaying (Bₐ^{s}) for cell A (in FIG. 5) are as follows, assuming that the traffic intensity in cell A, each tier B cell, and each tier C cell in the absence of relaying are Tₐ, T_{b} and T_{c} respectively with Tₐ>T_{b}>T_{c} and T_{f} to be the average traffic intensity of the system, Bₐ, B_{b} and B_{c} are the corresponding blocking probabilities without relaying, p is ARS coverage, and M is the number of DCH's in one cell,

$${B}_{a}^{p} = \frac{{( {T}_{a}^{p} )}^{M} / M !}{{\sum }_{i = o}^{M} {( {T}_{a}^{p} )}^{i} / i !} \begin{matrix}Δ \\ =\end{matrix} f ( {T}_{a}^{p} , M ) \qquad ( 1 )$$

where

Tₐ^{p}Tₐ−Tₚ(Tₐ−T_{f})(1−B_{b}),

and

Bₐ^{s}=f(Tₐ^{s}, M) (2)

where Tₐ^{s}=Tₐ^{p}−Rₐ^{s}, Rₐ^{s}=min {Uₐ^{p}, pTₐ^{p} (1−Bₐ^{p})(1−B_{b}^{p})} and Uₐ^{p}=Tₐ^{p}−T_{f}.

The iterative-equation approach addresses the performance improvement of iCAR due to its ability to balance the average traffic load among cells. In order to get more accurate results and show the capability of iCAR of overcoming the barriers imposed by cell boundaries, we develop another analytical model using multi-dimensional Markov chains. For simplicity, we only give the approximate modeling result here:

$${B}_{a}^{p} = Q ( M ) \times [ ( 1 - p ) + p \times b ] = \frac{{T}_{a}^{M} / M !}{{\sum }_{i = 0}^{M} {T}_{a}^{i} / i !} \times [ ( 1 - p ) \times p \times {B}_{b} ] \qquad ( 3 )$$

where Q(M) is the steady probability that the system is at the state (M) of the Markov chain, meaning that all M channels are occupied by users.

$${B}_{a}^{s} = {\sum }_{i = 0}^{M} Q ( i , M ) \times {B}_{b}^{i} \times [ ( 1 - p ) + p \times {B}_{b} ] \qquad ( 4 )$$

where Q(i,M) is the steady probability that the system is at state (i,M) of the two dimensional Markov chain, meaning that all neighboring cells are congested.

ARS Management

First, we note that having ARS's managed by MSC's is a unique but important feature of the proposed iCAR system, where routing, and especially QoS routing involves different issues than in mobile Ad-hoc networks. For example, with a reasonable number of ARS's deployed in each cell, there may be multiple relaying routes between an MH and different BTS's, but only one relaying route needs to be established. Accordingly, we must determine an appropriate (destination) BTS as well as an appropriate relaying route to that destination, subject to QoS requirements such as delay, throughput, route stability and/or power consumption and so on. In other words, the problem of identifying a relaying route in this case is similar to that of identifying an anycast (or one-to-any) connection, which is different from (and more difficult than) the problem of identifying a one-to-one connection in mobile Ad-hoc networks where a destination MH is specified by the request.

In addition, in case the number of ARS's in a (congested cell) is small, and secondary relaying is used, the problem becomes identifying an efficient relaying route between any MH in the cell and any BTS in other cells or in other words, a any-to-any routing problem. Below, we focus on how to manage the ARS's to facilitate routing, authentication of ARS's and MH's, billing as well as other call management functions whenever a call needs to be relayed.

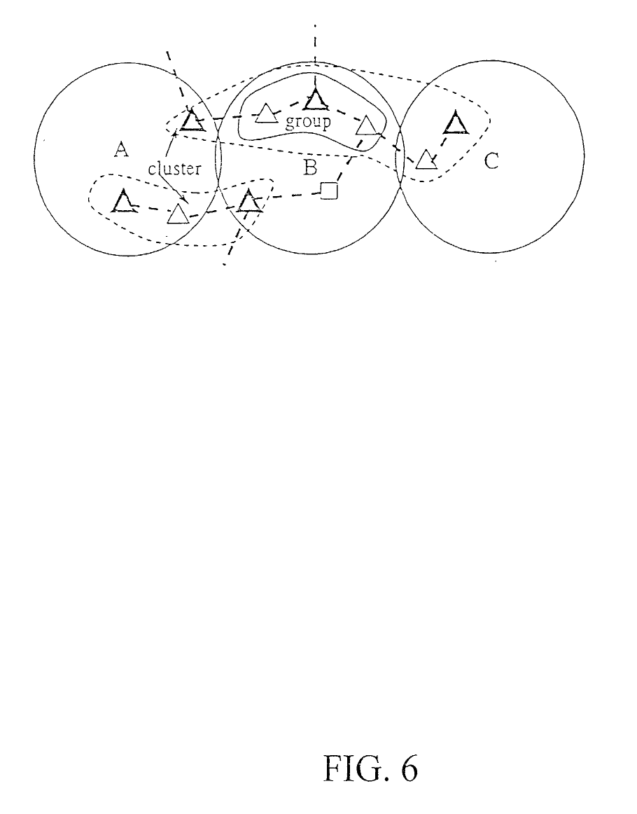

Having ARS managed by MSC's also allows ARSs to have managed mobility to follow certain MH's which are using relaying in a congested cell and hence at the risk of losing connections. GPS systems, for example, can be used by the ARS's and MH's to track their locations, and send their location information to each other. ARS's can also move around in order to form different “ARS clusters” (called groups in FIG. 6) to better serve current traffic (which changes dynamically).

As mentioned earlier, an ARS, when not relaying radio signals as a gateway ARS, does not use any DCH. This is an important reason why congestion induced relaying can effectively increase the capacity of the system and eliminate (or at least alleviate) congestion. However, an ARS, even when it is not relaying at all, will from time to time communicate with a BTS in the same cell on the C-interface using control channels (CCH's) that are shared by MH's and other ARS's. In this way, an ARS can exchange control messages (some pertaining to routing information) with an MSC that manages the ARS. An ARS outside the coverage of a cell can also exchange control messages with a nearby MSC via other ARS's.

Having every ARS managed by an MSC will undoubtedly increase the load on the CCH's. But because of the multiple-access nature of these CCH's, and the likelihood of having a relatively low control traffic load (when compared to data traffic load), sharing the CCH's may not be a problem, especially with evaluate efficient multiple-access schemes taking into consideration the specific characteristics of the control traffic, especially those to and from the ARS's.

The amount of control traffic on the CCH's introduced by having ARS's can also be reduced by using various hierarchical management approaches whereby a cluster of ARS's within a cell (called a group as shown in FIG. 6) will be represented by one ARS as a (group-) leader (shown as a bold triangle in FIG. 6) who exchanges control messages with the MSC controlling the cell. Compared to flat management approaches whereby every ARS exchanges control messages with a MSC on its own, the hierarchical approach can reduce the control information exchanged between ARS's and MSC's over the CCH's, but on the other hand, require the ARS's within each group to exchange control information using their R interfaces.

The amount of control overhead and/or power consumed by ARS's can also be reduced. For example, when the traffic load is low, one may put ARS's to “sleep.” In addition, those ARS's (or group leaders) that have not changed their connectivity in terms of their neighboring ARS's (or groups) do not have to communicate to a BTS. Finally, either MSC's may instruct ARS's, or ARS's may decide themselves, to adjust their transmission powers to adapt to different traffic conditions.

The present invention operates to overcome congestion, increase effective capacity of the system, extend cellular system's coverage in a flexible manner, provide interoperability between heterogeneous systems (by connecting ad hoc networks and wireless LANs to Internet for example), enhance reliability (or fault-tolerance) of the system, potentially improve MHs' battery life and transmission rate, and enable new services.

Thus, it is seen that the objects of the present invention are efficiently obtained, although modifications and changes to the invention should be readily apparent to those having ordinary skill in the art, and these modifications are intended to be within the spirit and scope of the invention as claimed.

What is claimed is:

1. A method for establishing a connection between a first mobile host and a second mobile host comprising:
identifying a first relaying station in communication range of said first mobile host;
identifying a communication path between said first relaying station and said second mobile host;
establishing a connection between said first mobile host and said first relaying station; and,
establishing a connection between said first relaying station and said second mobile host.

2. The method recited in claim 1 wherein said path from said first relaying station to said second mobile host is operatively arranged to allow direct communication between said first relaying station and said second mobile host.

3. The method recited in claim 1 wherein said path from said first relaying station to said second mobile host includes a connection with a base transceiver station.

4. The method recited in claim 1 wherein said path from said first relaying station to said second mobile host includes a connection with at least one additional relaying station.

5. The method recited in claim 1 wherein said first relaying station is mobile.

6. The method recited in claim 1 wherein said first relaying station is located equidistant between two base transceiver stations.

7. The method recited in claim 1 wherein said connection between said first relaying station and said first mobile host occurs at a relaying frequency.

8. The method recited in claim 7 wherein said relaying frequency is 2.4 GHz.

9. A method for establishing a connection between a first mobile host and a second mobile host within a system having a limited number of primary frequencies comprising:
identifying a first relaying station in communication range of a third mobile host currently using one of said primary frequencies;
replacing said connection of said third mobile host on one of said primary frequencies with a connection between said first relaying station and said third mobile host on a relaying frequency; and,
establishing a connection between said first and said second mobile host on said primary frequency made available by said connection between said first relaying station and said third mobile host on a relaying frequency.

10. The method recited in claim 9 wherein one of said primary frequencies is 850 MHz.

11. The method recited in claim 9 wherein said relaying frequency is 2.4 GHz.

12. The method recited in claim 9 wherein said first relaying station is mobile.

13. The method recited in claim 9 wherein said first relaying station is located equidistant between two base transceiver stations.

14. A method for establishing a connection between a first mobile host and a second mobile host within a system having a limited number of primary frequencies comprising:
identifying a third mobile host currently using a first primary frequency;
identifying a first relaying station in communication range of a fourth mobile host currently using a second primary frequency;
replacing said connection of said fourth mobile host on said second primary frequency with a connection between said second relaying station and said fourth mobile host on a relaying frequency;
replacing said connection of said third mobile host on said first primary frequency with a connection on said second primary frequency; and,
establishing a connection between said first and said second mobile host on said first primary frequency.

15. An apparatus for relaying communications between mobile hosts comprising:
wireless communication means for communication with a mobile switching center;
means to receive communication signals on a relaying frequency; and, means to send communication signals on a relaying frequency.

16. The apparatus recited in claim 14 further comprising:
means to receive communication signals on a primary frequency; and, means to send communication signals on a primary frequency.

17. The apparatus recited in claim 15 wherein said apparatus is mobile.

18. The apparatus recited in claim 16 wherein said primary frequency is 850 MHz.

19. The apparatus recited in claim 15 wherein said relaying frequency is 2.4 GHz.

20. An apparatus for relaying communications between mobile hosts comprising:
wireless communication means for communication with a mobile switching center;
means to receive communication signals on a primary frequency; and, means to send communication signals on a primary frequency.

21. The apparatus recited in claim 20 wherein said apparatus is mobile.

22. The apparatus recited in claim 20 wherein said primary frequency is 850 MHz.

23. An apparatus for establishing a connection between a first mobile host and a second mobile host comprising:
means for identifying a first relaying station in communication range of said first mobile host;
means for identifying a communication path between said first relaying station and said second mobile host;
means for establishing a connection between said first mobile host and said first relaying station; and,
means for establishing a connection between said first relaying station and said second mobile host.

24. An apparatus for establishing a connection between a first mobile host and a second mobile host within a system having a limited number of primary frequencies comprising:
means for identifying a first relaying station in communication range of a third mobile host currently using one of said primary frequencies;
means for replacing said connection of said third mobile host on one of said primary frequencies with a connection between said first relaying station and said third mobile host on a relaying frequency; and,
means for establishing a connection between said first and said second mobile host on said primary frequency made available by said connection between said first relaying station and said third mobile host on a relaying frequency.
